(19) United States
(12) Patent Application Publication
(10) Pub. No.: US 2018/0297780 A1
(43) Pub. Date: Oct. 18, 2018

(54) SPRING BIASED BEVERAGE COOLER

(71) Applicant: Cory Edward Steiner, Norwalk, IA (US)

(72) Inventor: Cory Edward Steiner, Norwalk, IA (US)

(21) Appl. No.: 15/956,182

(22) Filed: Apr. 18, 2018

Related U.S. Application Data
(60) Provisional application No. 62/486,537, filed on Apr. 18, 2017.

(51) Int. Cl. B65G 1/07; F25D 25/02; F25D 23/02

(52) U.S. Cl. CPC B65G 1/07; F25D 25/02; F25D 2331/803; F25D 2331/805; F25D 23/021

(57) ABSTRACT

The present invention relates to a beverage cooler that is spring biased in order to easily load, leverage, remove, and restock beverages for cooling. The spring biased beverage cooler includes an inner storage case within a compartment that is cooled by an evaporator. For access to the storage case, the top of the cooler includes sliding partitions. The storage case includes biased shelving that is separated by dividers that form storage sections within the storage case that receive beverage containers. The biased shelving includes a biased member to push shelves of the biased shelving toward the user for easy loading and removal of leveraged beverages on the shelving.

### CROSS REFERENCE TO RELATED APPLICATION

This application claims the benefit of U.S. Provisional Application No. 62/486,537 filed Apr. 18, 2017.

### BACKGROUND OF THE INVENTION

This invention is directed to a beverage cooler and more particularly a spring biased beverage cooler.

Beverage coolers, particularly for use in bars and restaurants are well-known in the art. Typically, these beverage coolers are elongated with sliding shelves on the top that provide access to a refrigerated storage compartment having wire dividers. To load the beverage cooler, an individual manually places bottles or cans into the storage compartment. Not only is this process labor intensive and time consuming, the repeated action of leaning over to place a beverage in the storage compartment and later to remove the beverage, particularly when the individual needs to reach to the bottom of the compartment, places strain on the individual's back and sometimes leads to injury. Also, it is difficult to rotate the beverages and as a result older and sometimes stale beverages remain at the bottom of the compartment.

Therefore, a need exists in the art for a cooler that addresses these problems.

### SUMMARY OF THE INVENTION

In general, the present invention relates to a beverage cooler that is spring biased in order to easily load, leverage, remove, and restock beverages for cooling. The spring biased beverage cooler includes an inner storage case within a compartment that is cooled by an evaporator. For access to the storage case, the top of the cooler includes sliding partitions. The storage case includes biased shelving that is separated by dividers that form storage sections within the storage case that receive beverage containers. The biased shelving includes a biased member to push shelves of the biased shelving toward the user for easy loading and removal of leveraged beverages on the shelving.

The spring biased beverage cooler is loaded with beverages by a user placing a beverage container for individual beverages onto the biased shelving of the inner storage case. The weight of the beverage container compresses the biased member such that the shelving moves toward the bottom of the beverage cooler. A desired amount of beverages is added to the beverage cooler. When beverages are removed from the beverage cooler, the decreasing weight upon the biased member causes the shelving to move upwards, bringing the next beverage to the reach of the user.

### BRIEF DESCRIPTION OF THE DRAWINGS

FIG. 1 is a side-sectional view of a spring biased beverage cooler; and

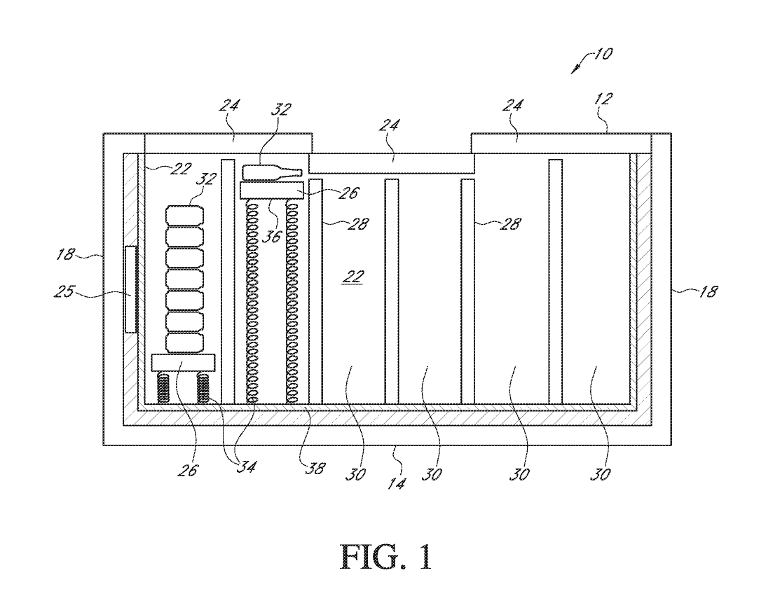

FIG. 2 is a top plan view of a spring biased beverage cooler.

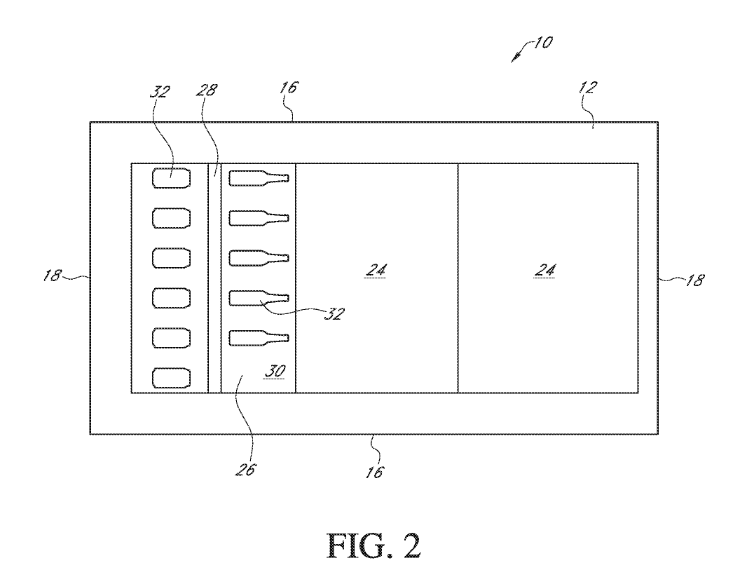

### DETAILED DESCRIPTION OF THE PREFERRED EMBODIMENTS

Referring to the Figures, a beverage cooler 10 has a top 12, a bottom 14, sidewalls 16 and end walls 18 that form a compartment 20. Within the compartment 20 is an inner storage case 22.

The top 12 of the cooler 10 has a plurality of sliding partitions 24 that provide access to the storage case 22. Between the side 16 and end 18 walls of the compartment 20 and the inner case 22 is an evaporator 25 for cooling the storage case 22.

Within the storage case are a plurality of biased shelves 26 that are separated by dividers 28. The dividers 28 extend from one side wall 16 to the opposite side wall and preferably from a bottom of the storage case 22 to the top. The dividers 28 and sidewalls 16, and at the ends, the end walls 18 form storage sections 30 that are sized to receive either a bottle or a can 32.

The shelves 26 have a biasing member 34 positioned between a bottom surface 36 of the shelf 26 and the bottom 38 of the storage case 22. The biased member 34 is of any type and includes one or more springs, a resilient pad, mechanical linkage, a pneumatic cylinder or the like. The shelves 26 remain generally horizontal and slide vertically within the storage section 30 based upon the thickness of the shelf 26 and frictional engagement against the dividers 28, sidewalls 6, and, at the ends, end walls 18. Alternatively, the shelves 26 have an attachment slide 27 that is slidably received within a guide 29 on the dividers 28. The tension of the biased member is sufficient to hold the shelf 26 near the top 12 of the cooler 10 in a first or normal position and move downwardly in incremental steps, preferably a distance equal to the width of a bottle or can 32 based upon the weight of a full bottle or can 32.

In operation, the cooler is loaded by manually placing a full bottle or can 32 onto a shelf 26. Based on the weight of the beverage 32, the biased member 34 is partially compressed and the shelf 26 moves downwardly an incremental amount. The process is repeated until the storage section 30 is full and the biased member 34 is fully compressed. As beverages are ordered, a can or bottle 32 is removed from the cooler causing the shelf 26 to move upwardly an incremental amount due to the removal of the weight of the bottle or can 32 and the tension of the biased member 34.

As a result, an individual does not have to bend down into the cooler to fill and empty the cooler with beverages. This reduces the effort, time, and potential for injury. Also, rotation is improved as an individual is more likely to empty a storage section before refilling.

From the above discussion and accompanying figures and claims it will be appreciated that the beverage cooler 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed:

1. A spring biased beverage cooler comprising:
a top having a plurality of sliding partitions;
a bottom;
a pair of sidewalls;
a pair of end walls;
a compartment formed by the plurality of sidewalls and the plurality of end walls;
an inner storage case positioned within the compartment;
an evaporator positioned between at least one side wall and at least one end wall;
a plurality of biased shelves positioned within the inner storage case;
a plurality of dividers positioned within the inner storage case separating the plurality of biased shelves and extending from at least one side wall to an opposite side wall; and
a biasing member positioned between a bottom surface of the biased shelves and a bottom of the inner storage case.

2. The spring biased beverage cooler of claim 1 wherein the dividers, sidewalls, and ends of the end walls form storage sections.

3. The spring biased beverage cooler of claim 2 wherein the storage sections are configured to receive an individual beverage container.

4. The spring biased beverage cooler of claim 1 wherein the biased member is at least one spring.

5. The spring biased beverage cooler of claim 1 wherein the biased member is a resilient pad.

6. The spring biased beverage cooler of claim 1 wherein the biased member is a mechanical linkage.

7. The spring biased beverage cooler of claim 1 wherein the biased member is a pneumatic cylinder.

8. The spring biased beverage cooler of claim 2 wherein the biased shelves remain generally horizontal and slide vertically within the storage sections based upon a thickness of the biased shelves and frictional engagement of the biased shelves against the dividers, sidewalls and the ends of the end walls.

9. The spring biased beverage cooler of claim 1 wherein the biased shelves further comprise at least one attachment slide that is slidably received within a guide positioned on at least one divider.

10. The spring biased beverage cooler of claim 1 wherein a tension of the biased member is sufficient to hold the biased shelving near the top of the spring biased cooler in a first position.

11. The spring biased beverage cooler of claim 10 wherein the tension of the biased member is sufficient to move the biased shelving downwardly in incremental steps a distance equal to the width of an individual beverage container.
